(19) United States
(12) Patent Application Publication
(10) Pub. No.: US 2013/0203002 A1
(43) Pub. Date: Aug. 8, 2013

(54) Customizable Candle and Candle Holder

(71) Applicant: Denise Aster, Drexel Hill, PA (US)

(72) Inventor: Denise Aster, Drexel Hill, PA (US)

(21) Appl. No.: 13/368,261

(22) Filed: Feb. 7, 2012

(51) Int. Cl. F21V 35/00

(52) U.S. Cl. 431/290; 431/291

(57) ABSTRACT

A customizable candle holder whose design is controlled by a user is described. The components of the candle holder comprise a base, a pillar, and a holder block. The components are designed such that the base supports the insertion of either the pillar or the holder block, and such that the pillar supports the insertion of the holder block. Therefore, the candle holder can be uniquely designed by a user with the incorporation of components of different or alternative designs. Candle holders of the invention can also comprise decorative charms, which can be removably attached to the holder thereby allowing more design freedom to the user.

### BACKGROUND OF THE INVENTION

There are numerous kinds of candles and candle holders known in the art, including candle sticks, candelabras, votives, floating candles, chandeliers, and the like. While candles were once used extensively to provide lighting, they are currently commonly used as decorative items that provide a desired ambiance.

In one example, candles are often used as memorials or as items of remembrance for loved ones who have since passed on. As such, the design of candles and candle holders can be of great importance to the user. While there are many designs of candles and candle holders in the art, there is a need for a candle holder which has a customizable design such that a given user can create their personal remembrance candle. For example, a user may want to design a candle holder for remembrance with adorations that signify religion or other important icons that would remind the user of their loved one.

In another example, candles are often used as decorative items. While there may be many designs of candles and candle holders in the art, it is often desired to customize the design of a decorative candle holder such that the design can be reversibly changed at any time. For instance, a user may wish to alter the size or color of a decorative candle holder. A user may also wish to add or change decorative adorations applied to the candle holder.

Thus, there is a need in the art for a customizable candle and candle holder to provide the desired ambiance in variable settings. The present invention satisfies this need.

### SUMMARY OF THE INVENTION

The present invention relates to a customizable candle holder assembly comprising a base having a bottom surface and a top surface, the top surface including a cavity; a pillar having a bottom surface, a top surface and at least one sidewall, the top surface including a cavity; and a holder block having bottom surface and a top surface, the top surface having a cavity. The bottom surface of the pillar is sized and shaped to fit within the base cavity, and the bottom surface of the holder block is sized and shaped to fit within either or both of the pillar cavity and the base cavity.

In one embodiment, the base includes a drawer. In another embodiment of the candle holder assembly, the pillar is a candle. The shape of the pillar may be a cylinder or a prism. In one embodiment, the holder block cavity is sized and shaped to hold a votive, candle, or votive holder.

In one embodiment, the pillar includes at least one decorative charm. In one embodiment, the sidewall of the pillar comprises at least one cavity, where, in one embodiment, a decorative charm is positioned.

In one embodiment, the cavity of the base has four sides, where, in one embodiment, the sides are curved. Similarly, in one embodiment, the cavity of the pillar has four sides, where, in one embodiment, the sides are curved. In another embodiment, the cavity of the holder block is cylindrical.

In one embodiment of the invention, the top surface of the base is arched.

In one embodiment, the holder block has at least one sidewall that defines an outer perimeter. In one embodiment, the outer perimeter is greater than the perimeter of the bottom surface of the holder block. In another embodiment, the outer perimeter of the holder block is substantially the same as the perimeter of the pillar.

In one embodiment of the invention, the pillar has four sidewalls. In one embodiment, the sidewalls of the pillar are curved.

### BRIEF DESCRIPTION OF THE DRAWINGS

For the purpose of illustrating the invention, there are depicted in the drawings certain embodiments of the invention. However, the invention is not limited to the precise arrangements and instrumentalities of the embodiments depicted in the drawings.

FIG. 1 is a perspective view illustrating an exemplary candle holder of the present invention.

FIG. 2 is a perspective view illustrating the exemplary candle holder of FIG. 1 with the drawer in an opened configuration.

FIG. 3 is an exploded view of the exemplary candle holder of FIG. 1.

FIG. 4 is a perspective view of an exemplary candle holder base and drawer of the invention.

FIG. 5 depicts a top view, back view, front view, and side view of the candle holder base of FIG. 4.

FIG. 6 depicts a top view, front view, and side view of the drawer of FIG. 4.

FIG. 7 is a perspective view of the pillar component of the candle holder of the invention.

FIG. 8 depicts a top view, a side view, and a front view of the pillar component of the candle holder of FIG. 7.

FIG. 9 is a perspective view of the candle holder block of the invention.

FIG. 10 depicts a side view and top view of the candle holder block of FIG. 9.

FIG. 11 depicts two alternate embodiments of the candle holder of the invention.

### DETAILED DESCRIPTION

It is to be understood that the figures and descriptions of the present invention have been simplified to illustrate elements that are relevant for a clear understanding of the present invention, while eliminating, for the purpose of clarity, many other elements found in candle holders. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Unless defined otherwise, all technical and scientific terms used herein have the same meaning as commonly understood by one of ordinary skill in the art to which this invention belongs. Although any methods, materials and components similar or equivalent to those described herein can be used in the practice or testing of the present invention, the preferred methods and materials are described.

As used herein, each of the following terms has the meaning associated with it in this section.

The articles “a” and “an” are used herein to refer to one or to more than one (i.e., to at least one) of the grammatical object of the article. By way of example, “an element” means one element or more than one element.

“About” as used herein when referring to a measurable value such as an amount, a temporal duration, and the like, is meant to encompass variations of ±20% or ±10%, more preferably ±5%, even more preferably ±1%, and still more preferably ±0.1% from the specified value, as such variations are appropriate to perform, make or use the disclosed invention.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 2.7, 3, 4, 5, 5.3, 6 and any whole and partial increments therebetween. This applies regardless of the breadth of the range.

The present invention relates to a customizable candle holder that can be assembled in multiple configurations and designs as defined by the user. As such, the candle holder of the invention comprises a multitude of individual pieces that, when pieced together, form the different embodiments of the invention.

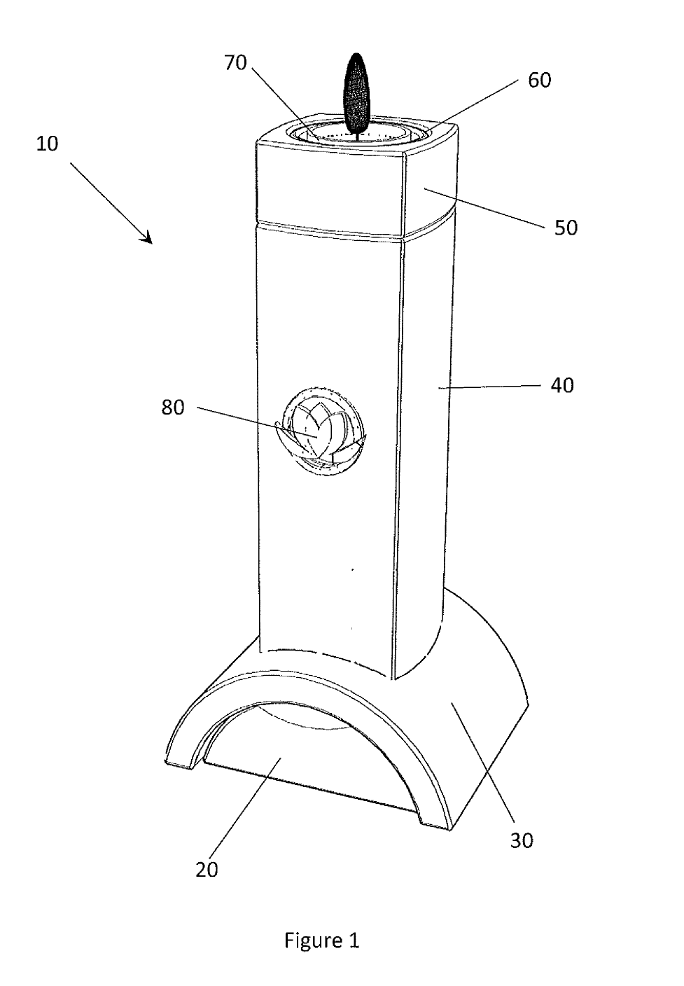

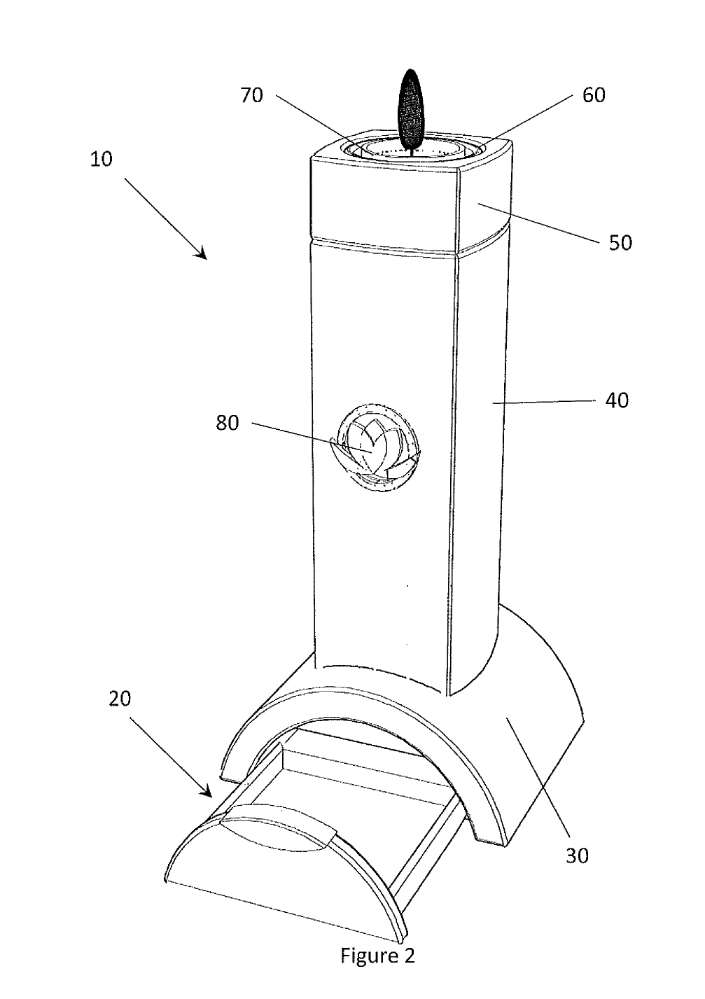

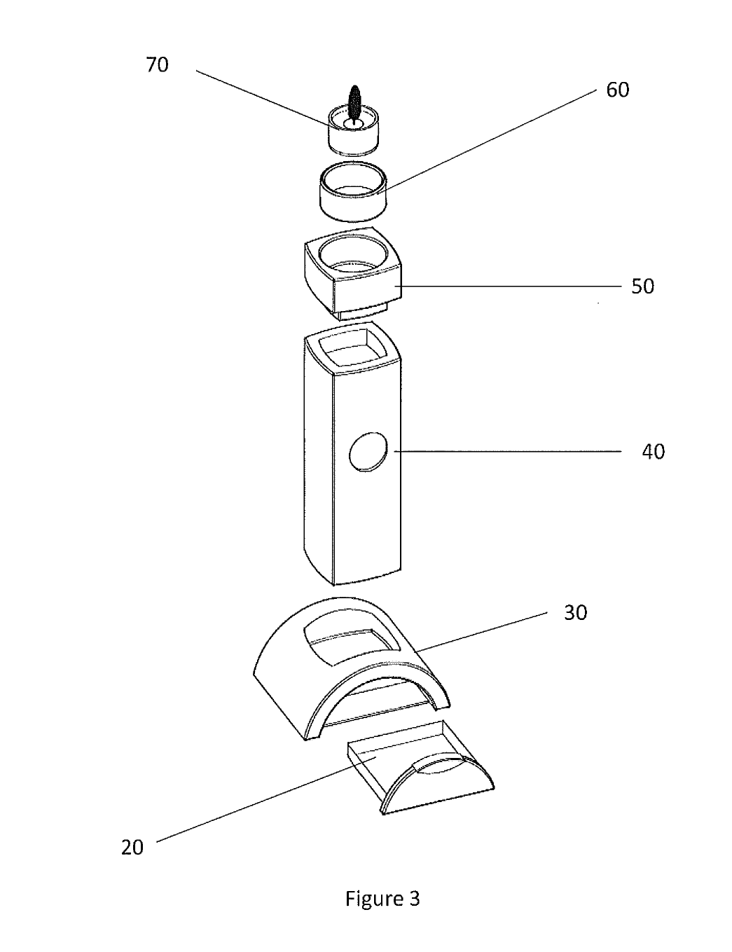

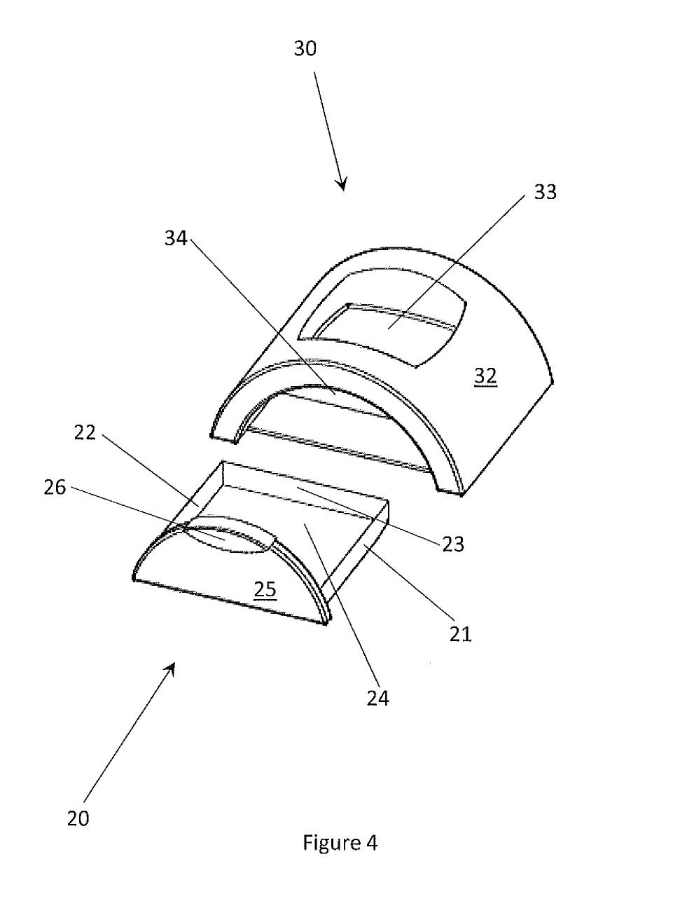

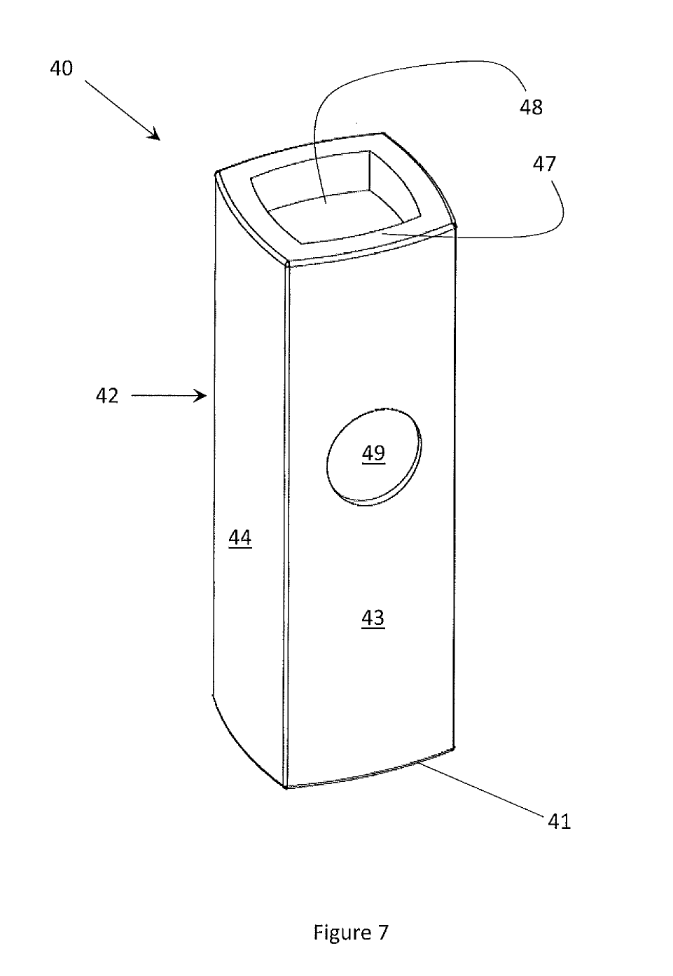

According to an aspect of the present invention and as shown generally in FIGS. 1-3, a candle holder 10 comprises a candle holder base 30, a pillar 40, a candle holder block 50, an optional drawer 20 in candle holder base 30, an optional votive holder 60 for holding a votive 70, and an optional decorative charm 80. In one embodiment, candle holder base 30 is suitable for supporting candle holder 10 when placed upon a surface. In the embodiment as exemplified in FIG. 2, candle holder 10 may optionally include a slidable and/or retractable drawer 20 for storing items. The opening and closing mechanism of drawer 20 may be any mechanism understood by those skilled in the art, including flange and groove, slides, hinging and the like. Pillar 40, which may be removably inserted into cavity 33 (FIG. 4) of candle base holder 30, extends upward from candle base holder 30. Candle holder block 50 may be sized and shaped to be removably inserted into cavity 48 (FIG. 7) of pillar 40. The top of candle holder block 50 may optionally support the placement of votive holder 60 and votive 70, which sits within votive holder 60. Further, pillar 40 may include one or more decorative charms 80. Decorative charms 80 may be fixedly or removably attached to any portion or location of pillar 40 by mechanisms understood by those skilled in the art, such as by adhesive, friction fit into a cavity, hangers, or embedded into the material of pillar 40.

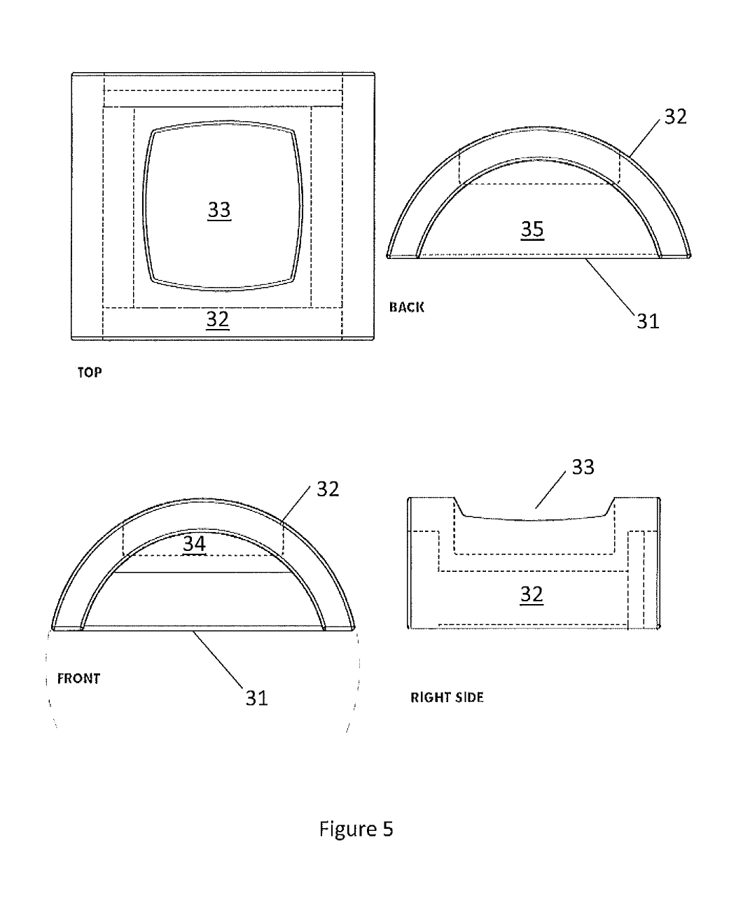

As contemplated in FIGS. 4 and 5, candle holder base 30 comprises a base support member 31, a top structure or surface 32, a cavity 33 within top structure 32, a front panel 34, and a back panel 35. Candle holder base 30, as depicted in FIG. 4, can have an arched shape. However, candle holder base 30 of the invention is not limited in its particular shape. For example, candle holder base 30 may also have a spherical, rectangular, pyramid or other polyhedral shape. The shape of candle holder base 30 is only limited in the fact that it includes cavity 33 and maintains candle holder 10 in an upright state when placed upon a substantially level surface. Similarly, the present invention is not limited as to the shape of cavity 33 or the depth of cavity 33. The shape of cavity 33 can be of any shape that supports the removable insertion of pillar 40. In one embodiment cavity 33 can be of any shape that supports the removable insertion of pillar 40 or of candle holder block 50. As such, cavity 33 of candle holder base 30 is designed such that the user can define whether to include pillar 40 in the structure of the candle holders of the invention. The depth of cavity 33 should be of any depth that provides structural stability of candle holder 10 when pillar 40 or candle holder block 50 is inserted into cavity 33. As such, cavity 33 may be of any depth that prevents inserted pillar 40 or candle holder block 50 from toppling out of candle holder base 30. Front panel 34 may extend from top structure 32 to base 31 at the front face of candle holder base 30. In one embodiment, wherein candle holder 10 comprises drawer 20, front panel 34 is a partial wall extending downward from top structure 32, leaving a partially open gap from which drawer 20 extends out from candle holder base 30. In another embodiment, wherein candle holder comprises drawer 20, front panel 34 is not included. In another embodiment, wherein candle holder 10 does not comprise optional drawer 20, front panel 34 is a solid panel spanning the entire gap between top structure 32 and base 31. Back panel 35 extends from top structure 32 to base 31 at the back face of candle holder base 30. It should be noted that the invention is not limited to the inclusion of front panel 34 or back panel 35. As such, in one embodiment candle holder base 30 does not include either front panel 34 or back panel 35. Candle holder base 30 can be made of any material known in the art to provide stability in the support the candle holders of the invention. Non-limiting examples of suitable materials include wood, plastic, ceramic, glass, metal or any combination thereof.

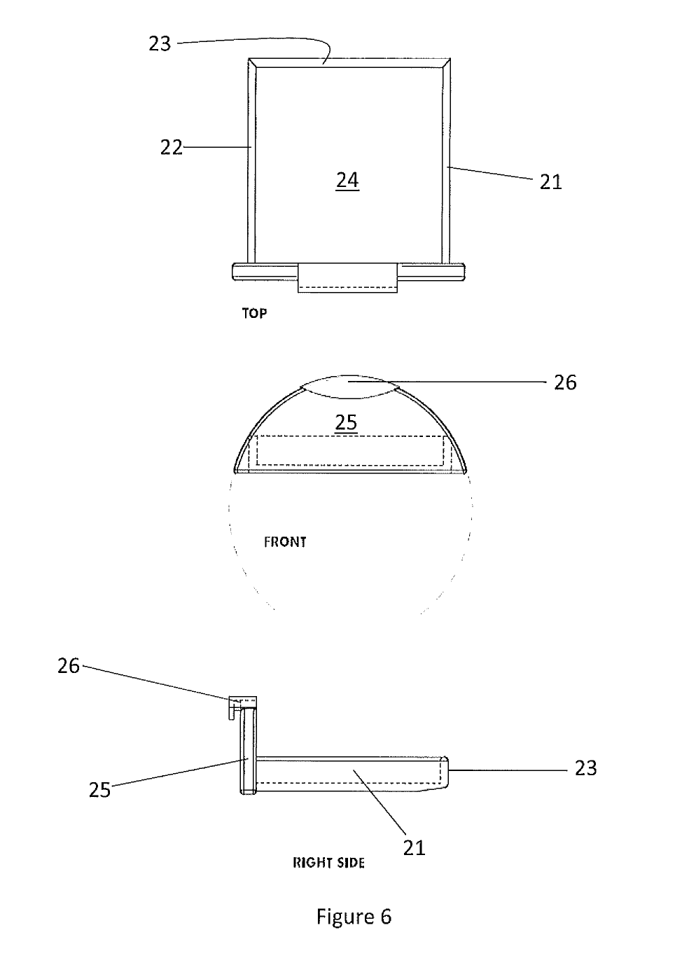

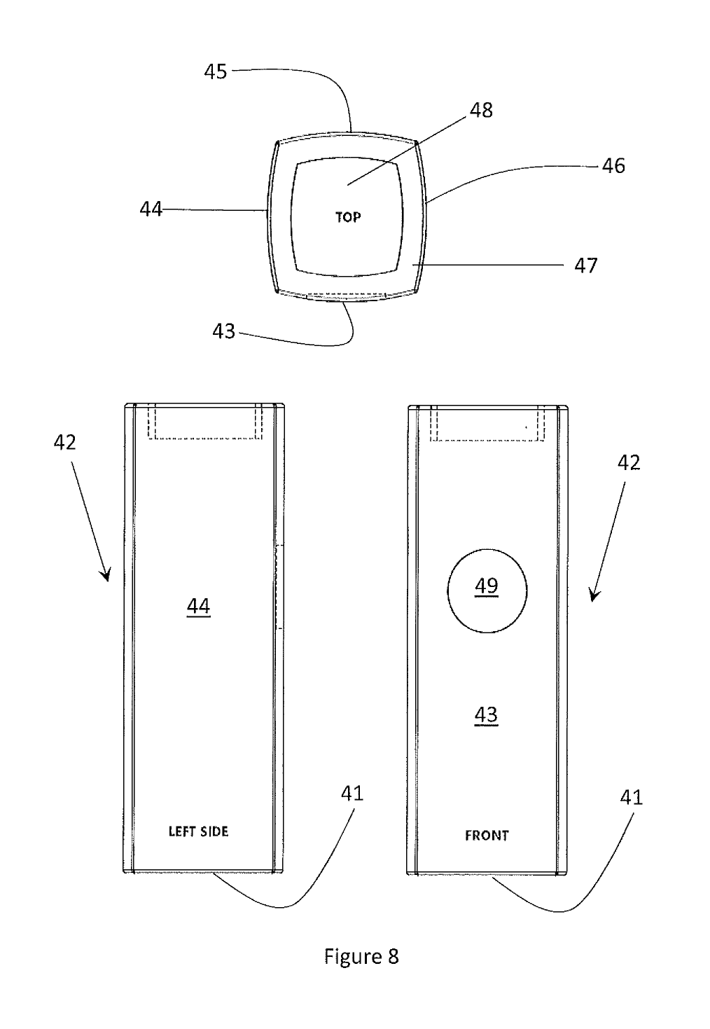

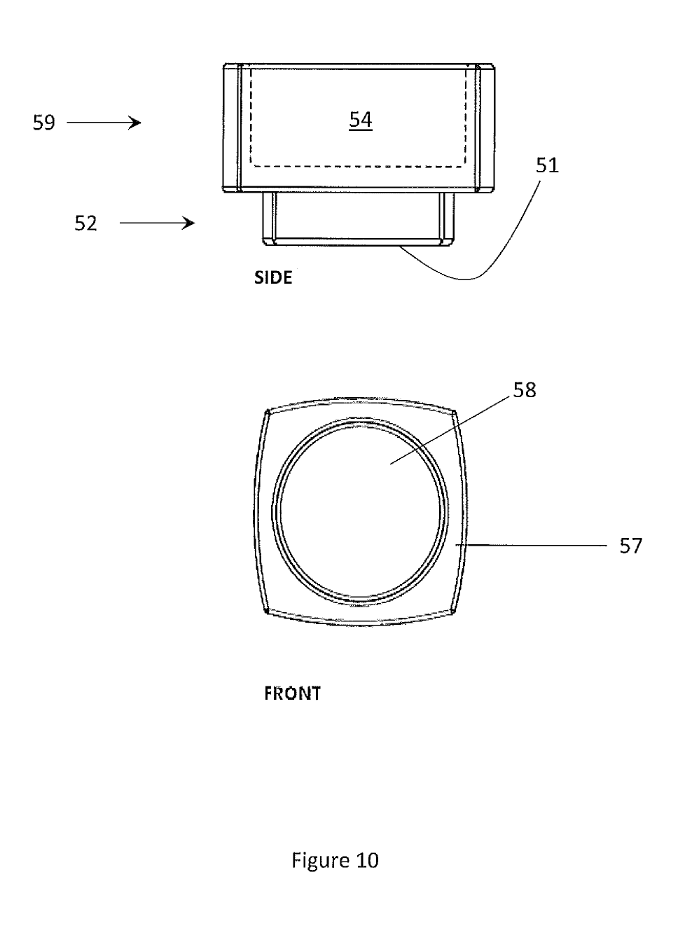

As contemplated in FIGS. 4 and 6, drawer 20 comprises side panels 21 and 22, a back panel 23, a drawer base 24, a front panel 25, and a handle 26. As depicted in FIG. 8, and as described elsewhere herein, drawer 20 extends from within candle holder base 30. Side panels 21 and 22, along with back panel 23 and base 24 together form the drawer tray of drawer 20. It is noted that drawer 20 is not limited by shape or size of the drawer tray. As such, while FIG. 10 depicts the drawer tray as having a rectangular shape, the drawer tray may also have, for example, an arched or triangular shape. Similarly, while front panel 25 is shown to have an arched shape in FIG. 6, it should be understood that front panel 25 is likewise not limited as to potential shape or size. Front panel 25, side panels 21 and 22, back panel 23, and drawer base 24 can be constructed of any material known in the art. Non-limiting examples of exemplary materials include wood, plastic, ceramic, glass, metal or any combination thereof. Handle 26 extends away from front panel 25 at a distance that allows for the grasping of handle 26 by a user. Drawer 20 is not limited by the placement of handle 26 on front panel 25. For example, handle 26 can be positioned along the top of front panel 25, as depicted in FIG. 6. However, handle 26 can also be positioned in the center or bottom of front panel 25. Further, drawer 20 is not limited as to the number of handles 26 that can be present on front panel 25. Handle 26 can be of any shape or size, and can be constructed of any material. In one embodiment, handle 26 is constructed of the same material as the other components of drawer 20. In another embodiment, handle 26 is constructed of a different material compared to the other components of drawer 20.

As contemplated in FIGS. 7 and 8, pillar 40 comprises a base support member 41, a shaft portion 42, side walls 43-46, a top structure or surface 47, a cavity 48 within top structure 47, and a wall cavity 49. As described elsewhere herein, pillar 40 is shaped to be removably inserted into candle holder base 30 through insertion of base 41 of pillar 40 into cavity 33 of candle base holder 30. Pillar 40 is not limited by its height. Pillar 40 is also not limited by the material in which it is constructed. Non-limiting examples of exemplary materials that may be used to construct pillar 40 include wood, plastic, ceramic, glass, metal or any combination thereof. In one embodiment, pillar 40 is itself a candle. In this embodiment, pillar 40 and wick (not shown) are manufactured from any material known in the art suitable for a candle. Non-limiting examples of such materials include paraffin, stearin, beeswax, gel, plant wax, tallow, and spermaceti. In another embodiment, pillar 40 is a flameless candle, comprising a light, for example an LED light. In one embodiment, the light is positioned similar to a wick thereby resembling a candle flame. The light can also be positioned anywhere within or on the perimeter of pillar 40. Power can be supplied to the flameless candle by any method known in the art, for example battery, solar, electricity, and the like.

As depicted in FIG. 8, pillar 40 comprises walls 43-46 which define the four sides of shaft 42. However, it should be understood that pillar 40 is not limited by the number of walls. For example, shaft 42 may comprise 3, 4, 5, 6, 7, 8, 9, 10, etc. walls. In one embodiment, pillar 40 is a prism. Non-limiting examples of prisms include a triangular prism, a cube, a rectangular prism, a pentagonal prism, and an irregular prism. In another embodiment, shaft 42 is cylindrical. In one embodiment, shaft 42 comprises two regions, a first region removably inserted into cavity 33 and a second region extending from the first region. In one embodiment, as depicted in FIG. 8, the first region and second region of shaft 42 have the same shape such that they form one continuous shaft. In another embodiment, the first region and second region have different shape or are of different size. In this embodiment, the first region of shaft 42 is shaped to fit within cavity 33, while the second region of shaft 42 may be of any shape or size. The shapes of the first region of shaft 42 and of base support member 41 is only limited as to a shape that snugly fits within cavity 33 of candle holder base 30.

The present invention is not limited as to the shape of cavity 48 or the depth of cavity 48. The shape of cavity 48 can be of any shape the supports the removable insertion of candle holder block 50. The depth of cavity 48 should be of any depth that provides structural stability of candle holder 10 when candle holder block 50 is inserted into cavity 48. As such, cavity 48 may be of any depth that prevents inserted candle holder block 50 from toppling out of pillar 40. In the embodiment wherein pillar 40 is itself a candle, a wick extends out of shaft 42 through top structure 47 (not shown). In this embodiment, it would be known that the wick extends through all or a portion of the body of pillar 40, from base structure member 41 through shaft 42 and out top surface 47. The wick may extend out of any portion of top surface 47. In one embodiment, the wick extends out from the base of cavity 48. Wall cavity 49 forms a recessed space within any of the walls of shaft 42. In one embodiment, wall cavity 49 is present in one wall of shaft 42. However, the invention is not limited as to how many wall cavities 49 are present along pillar 40. For example, shaft 42 can comprise wall cavities 49 on all, some, or none of the pillar walls. Further, the invention is not limited as to the number of wall cavities 49 on an individual wall. For example, in one embodiment, a wall of shaft 42 can comprise 1, or 2, or 3, or 4, or 5, etc. wall cavities 49. Wall cavity 49 is not limited by its shape or size. For example, while wall cavity 49 is shown as circular indentation in FIG. 8, wall cavity can also be triangular, rectangular, or alternatively have an irregular shape. Wall cavity 49 are shaped and sized to allow a user to insert a decorative charm of the user's choosing into or onto pillar 40.

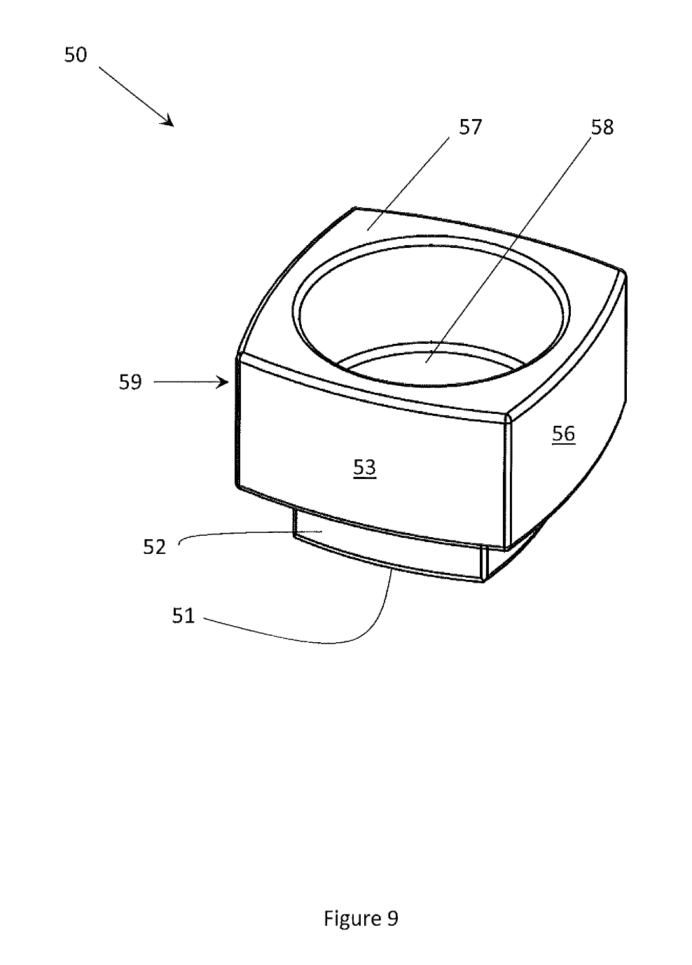

As contemplated in FIGS. 9 and 10, candle holder block 50 comprises base support member 51, a first shaft 52, walls 53-56, top structure or surface 57, cavity 58 in top structure 57, and a second shaft 59. In one embodiment, candle holder block 50 fits into pillar 40 through insertion of first shaft 52 of candle holder block 50 into cavity 48 of pillar 40. In another embodiment of the invention, candle holder block 50 fits into candle holder base 30 through insertion of first shaft 52 of candle holder block 50 into cavity 33 of candle holder base 30. Similar to pillar 40, described elsewhere herein, candle holder block 50 is not limited by size, shape, height, or material. As such, the size and shape of first shaft 52 and base support member 51 is only limited such that it can be positioned (either snuggly or loosely) both within cavity 48 of pillar 40 and cavity 33 of candle holder base 30. In one embodiment, the size and shape of first shaft 52 differs from that of second shaft 59, such that shaft 59 is substantially the same size and shape of shaft 42 of pillar 40. Thus, similar to shaft 42 of pillar 40 described elsewhere herein, first shaft 52 and second shaft 59 are not limited by the number of walls that encompass first shaft 52 and second shaft 59. Cavity 58 in top structure 57 is not limited as to its shape or depth. The shape of cavity 58 can be of any shape the supports the removable insertion of a candle, votive, or votive holder. Therefore, the shape of cavity 58 may be cylindrical, rectangular, triangular, or alternatively cavity 58 may have irregular shape.

In one embodiment candle 70 is inserted into cavity 58. In another embodiment, more than one candle 70 is inserted into cavity 58. In yet another embodiment, holder 60 is inserted into cavity 58. In this embodiment, candle 70 is then inserted into holder 60. Candle 70 and wick (not shown) are manufactured from any material known in the art suitable for a candle. Non-limiting examples of such materials include paraffin, stearin, beeswax, gel, plant wax, tallow, and spermaceti. In another embodiment, candle 70 is a flameless candle, comprising a light, for example an LED light. In one embodiment, the light is positioned similar to a wick thereby resembling a candle flame. The light can also be positioned anywhere within or on the perimeter of candle 70. Power can be supplied to the flameless candle by any method known in the art, for example battery, solar, electricity, and the like.

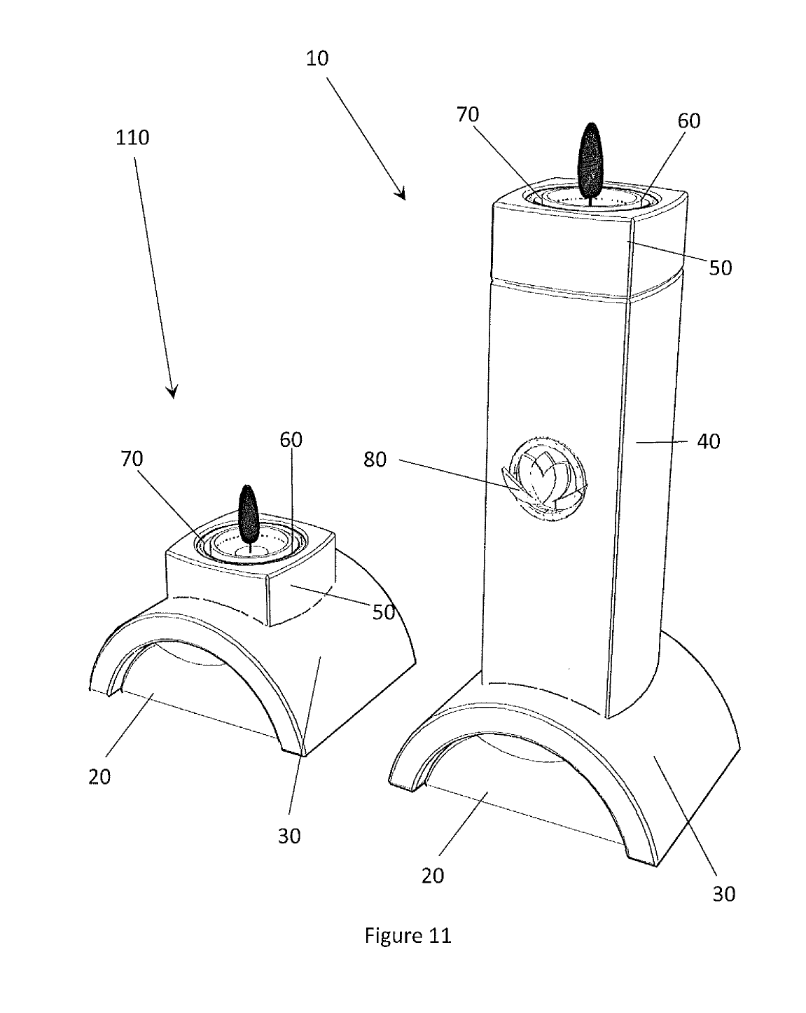

The present invention is directed to a customizable candle holder, wherein a user defines the structure and design of the candle holder. As such, the candle holder of the invention can be assembled in different configurations. As depicted in FIG. 11, the candle holder of the invention can comprise or not comprise pillar 40. That is, in one embodiment, candle holder 10 comprises pillar 40. In another embodiment, candle holder 110, does not comprise pillar 40. Candle holder base 30 is therefore designed such that it supports the insertion of either pillar 40 or candle holder block 50. In this way, the user can define the structure of the invention according to their preference. The height of the candle holder of the invention is thus customizable based on the desires of the user. If pillar 40 is itself a candle, pillar 40 is suitable for supporting a votive (through the insertion of candle holder block 50) or for use as a candle to be lit (with candle holder block 50 removed).

The design of the candle holder of the invention is further customizable though the placement of user defined decorative charms 80 either in wall cavities 49 of pillar 40 or directly on or in the planar surface of one or more sidewalls. For example, any charm 80 can be placed in cavity 49. Therefore, charm 80 is not limited in its design, size, or material so long as it fits within the cavity. In another embodiment, charm 80 is affixed to pillar 40 by use of, for example, adhesives or hangers, thereby not requiring cavity 49. Charms are used by the user to personalize and/or customize the candle holder of the invention. For example, charms can depict religious icons, holiday-specific ornaments, logos, emblems, and the like. In one embodiment, charms are easily interchangeable, such that the user can design and re-design the candle holder of the invention depending on the mood or season.

As the candle holder of the invention is assembled with the various components of the invention (candle holder base, pillar, candle holder block, etc.), the candle holder is also customizable with respect to the design of each component. For example, in one embodiment, the user assembles the candle holder using components made of the same material, or having the same color. In another embodiment, the user assembles the candle holder using components that are made of different materials, or of different color. Therefore, the present invention is directed towards candle holder components (candle holder base, pillar, candle holder block, etc.) of different size, color, style, or design that can be used interchangeably to assemble a customized candle holder. Components of the candle holder of the invention are only limited in that they fit together to form a stable candle holder. In this way, the user can reversibly design a customized candle holder according to their personal preferences.

While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed:

1. A customizable candle holder assembly comprising:
a base having a bottom surface and a top surface, the top surface including a cavity;
a pillar having a bottom surface, a top surface and at least one sidewall, the top surface including a cavity; and
a holder block having bottom surface and a top surface, the top surface having a cavity;
wherein the bottom surface of the pillar is sized and shaped to fit within the base cavity, and the bottom surface of the holder block is sized and shaped to fit within either or both of the pillar cavity and the base cavity.

2. The assembly of claim 1, wherein the base further comprises a drawer.

3. The assembly of claim 1, wherein the pillar is a candle.

4. The assembly of claim 3, wherein the candle is a flameless candle.

5. The assembly of claim 1, wherein the shape of the pillar is at least one selected from the group consisting of a cylinder and a prism.

6. The assembly of claim 1, wherein the cavity of the holder block is sized and shaped to hold a votive holder.

7. The assembly of claim 1, wherein the cavity of the holder block is sized and shaped to hold a votive.

8. The assembly of claim 1, wherein the cavity of the holder block is sized and shaped to hold a candle.

9. The assembly of claim 8, wherein the candle is a flameless candle.

10. The assembly of claim 1, wherein the pillar further comprises at least one decorative charm.

11. The assembly of claim 1, wherein the at least one sidewall of the pillar comprises at least one cavity.

12. The assembly of claim 11, wherein a decorative charm is positioned within the at least one cavity of the at least one sidewall.

13. The assembly of claim 1, wherein the cavity of the base comprises four sides.

14. The assembly of claim 13, wherein the sides of the cavity of the base are curved.

15. The assembly of claim 1, wherein the cavity of the pillar comprises four sides.

16. The assembly of claim 15, wherein the sides of the cavity of the pillar are curved.

17. The assembly of claim 1, wherein the cavity of the holder block is cylindrical.

18. The assembly of claim 1, wherein the top surface of the base is curved.

19. The assembly of claim 1, wherein the holder block further comprises at least one sidewall that creates an outer perimeter

20. The assembly of claim 19, wherein the outer perimeter of the holder block is greater than the perimeter of the bottom surface of the holder block.

21. The assembly of claim 19, wherein the outer perimeter of the holder block is substantially the same as the perimeter of the pillar.

22. The assembly of claim 1, wherein the pillar comprises four sidewalls.

23. The assembly of claim 22, wherein the sidewalls of the pillar are curved.
